(19) United States
(12) Patent Application Publication
(10) Pub. No.: US 2025/0230912 A1
(43) Pub. Date: Jul. 17, 2025

(54) VEHICLE LAMP, PROJECTION ASSEMBLY, AND VEHICLE

(71) Applicant: BEIJING CHEHEJIA AUTOMOBILE TECHNOLOGY CO., LTD., Beijing (CN)

(72) Inventors: Bolin SUN, Beijing (CN); Binbin TANG, Beijing (CN); Shiying ZHANG, Beijing (CN)

(21) Appl. No.: 18/859,782

(22) PCT Filed: Apr. 26, 2023
(86) PCT No.: PCT/CN2023/090953

§ 371 Date: Oct. 24, 2024

(30) Foreign Application Priority Data
Apr. 29, 2022 (CN) 202221046444.5

(51) Int. Cl. F21S 41/32; F21S 41/147; F21S 41/25; F21W 102/155; F21Y 115/10

(52) U.S. Cl. CPC F21S 41/32; F21S 41/147; F21S 41/25; F21W 2102/155; F21Y 2115/10

(57) ABSTRACT

A projection assembly includes a plurality of optical units, and each optical unit includes a reflecting mirror and a lens. The reflecting mirror has a light reflecting surface, and the lens has a light incident surface, the light incident surface is arranged corresponding to the light reflecting surface. Each optical unit has an optical axis extending along an X direction, and the light reflecting surface and the corresponding light incident surface are arranged along the X direction. Part of the plurality of optical units is an asymmetric unit, and the asymmetric unit satisfies that the optical axis and the geometric centerline of the light reflecting surface are spaced apart along a Y direction in a same asymmetric unit.

### CROSS-REFERENCE TO RELATED APPLICATIONS

The present application is a national stage entry under 35 U.S.C. § 371 of International Application No. PCT/CN2023/090953, filed on Apr. 26, 2023, which claims priority to Chinese Patent Application No. 202221046444.5, filed on Apr. 29, 2022, the entire disclosures of which are hereby incorporated herein by reference.

### FIELD

The present disclosure relates to the field of automobile accessory technologies, and in particular to a projection assembly, a vehicle lamp and a vehicle.

### BACKGROUND

A low beam lamp of an automobile includes a light source, a reflecting mirror and a lens.

A plurality of light sources are provided, the reflecting mirror has a plurality of light reflecting surfaces, and the lens has a plurality of light incident surfaces. The light source, the light reflecting surface and the corresponding light incident surface form an optical unit. The plurality of light sources, the plurality of light reflecting surfaces and the plurality of light incident surfaces form a plurality of optical units. In each optical unit, light emitted by the light source is reflected by the corresponding light reflecting surface and converged near a focus of the corresponding light incident surface. Light emitted by the plurality of light sources is finally refracted to a road surface through the lens to form an illumination.

### SUMMARY

A projection assembly of embodiments of the present disclosure includes a plurality of optical units, and each optical unit includes a reflecting mirror and a lens. The reflecting mirror has a light reflecting surface, the lens has a light incident surface, and the light incident surface is arranged corresponding to the light reflecting surface. Each optical unit has an optical axis extending along an X direction, and the light reflecting surface and the corresponding light incident surface are arranged along the X direction. Part of the plurality of optical units is an asymmetric units, and the asymmetric unit satisfies that the optical axis and a geometric centerline of the light reflecting surface are spaced apart along a Y direction in a same asymmetric unit.

A vehicle lamp of embodiments of the present disclosure includes the projection assembly according to any of the above embodiments.

A vehicle of embodiments of the present disclosure includes the vehicle lamp according to any of the above embodiments.

### BRIEF DESCRIPTION OF THE DRAWINGS

FIG. 1 is a perspective view of a projection assembly according to one embodiment of the present disclosure.

FIG. 2 is a front view of a projection assembly according to one embodiment of the present disclosure.

FIG. 3 is a top view of a projection assembly according to one embodiment of the present disclosure.

FIG. 4 is a perspective view of a first asymmetric unit group and a second asymmetric unit group in FIG. 3.

FIG. 5 is a front view of a first asymmetric unit group and a second asymmetric unit group in FIG. 3.

FIG. 6 is a top view of a first asymmetric unit group and a second asymmetric unit group in FIG. 3.

FIG. 7 is a beam pattern effect diagram of a first asymmetric unit in FIG. 6.

FIG. 8 is a beam pattern effect diagram of a second asymmetric unit in FIG. 6.

FIG. 9 is a beam pattern effect diagram formed by a first asymmetric unit and a second asymmetric unit in FIG. 6 in a superimposed manner.

FIG. 10 is a beam pattern effect diagram of a third asymmetric unit in FIG. 6.

FIG. 11 is a beam pattern effect diagram of a fourth asymmetric unit in FIG. 6.

FIG. 12 is a beam pattern effect diagram formed by a third asymmetric unit and a fourth asymmetric unit in FIG. 6 in a superimposed manner.

FIG. 13 is a beam pattern effect diagram formed by four asymmetric units in FIG. 6 in a superimposed manner.

FIG. 14 is a beam pattern effect diagram formed by all optical units in FIG. 3 in a superimposed manner.

FIG. 15 is an exploded view of a vehicle lamp according to one embodiment of the present disclosure.

FIG. 16 is a front view of a vehicle lamp according to one embodiment of the present disclosure (with a radiator hidden).

FIG. 17 is an A-A view of FIG. 16.

FIG. 18 is an exploded view of a lens, a light-blocking member, and a frame in FIG. 15.

FIG. 19 is a perspective view of a lens in FIG. 15.

FIG. 20 is a perspective view of a reflecting mirror in FIG. 15.

FIG. 21 is a front view of a reflecting mirror in FIG. 15.

FIG. 22 is a B-B view of FIG. 21.

### DETAILED DESCRIPTION

Embodiments of the present disclosure are described in detail below, and examples of embodiments are illustrated in accompanying drawings. Embodiments described below with reference to the accompanying drawings are illustrative and are intended to be used to explain the present disclosure, and cannot be understood as limitation of the present disclosure.

In the related art, a beam pattern formed by each optical unit is a left-right symmetrical beam pattern, resulting in more energy in a middle of each optical unit and less energy on left and right sides, which ultimately leads to poor road illumination uniformity.

A vehicle lamp includes a low beam lamp and a high beam lamp. Light of the high beam lamp is emitted in parallel, and the light is concentrated with a high brightness, which may illuminate a higher and farther object. Light emitted by the low beam lamp is emitted in a divergent state, and may illuminate an object in a larger range nearby. As an eye of an automobile, the vehicle lamp is not only related to an external image of a vehicle owner, but also closely related to safe driving at night or in a bad weather condition. Therefore, a road illumination effect of the vehicle lamp is crucial for the safe driving. In the related art, the low beam lamp has more energy in the middle and less energy on both sides, resulting in a poor uniformity of road illumination.

Based on at least one of the above problems, embodiments of the present disclosure provides a projection assembly, a vehicle lamp and a vehicle, which may effectively increase the energy of at least one side of a beam pattern formed by the projection assembly, thereby improving the road illumination uniformity of the vehicle lamp with the projection assembly and thereby improving driving safety.

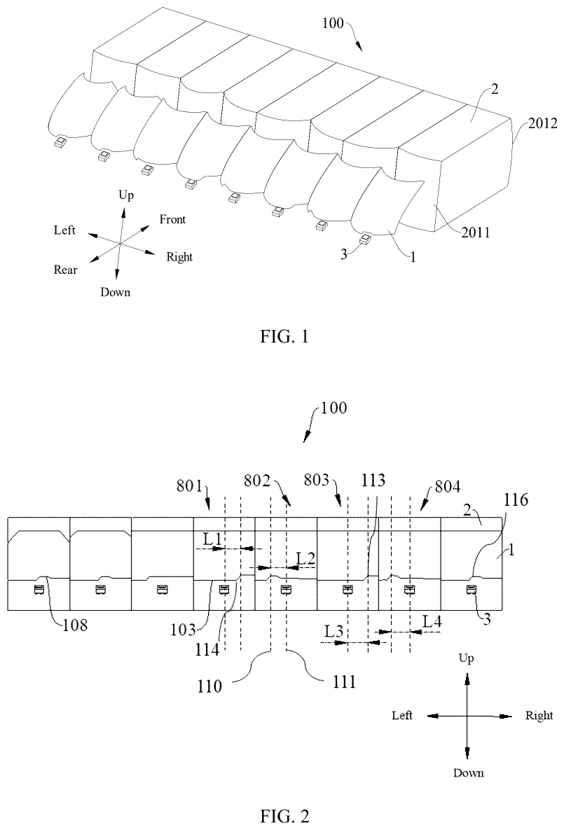

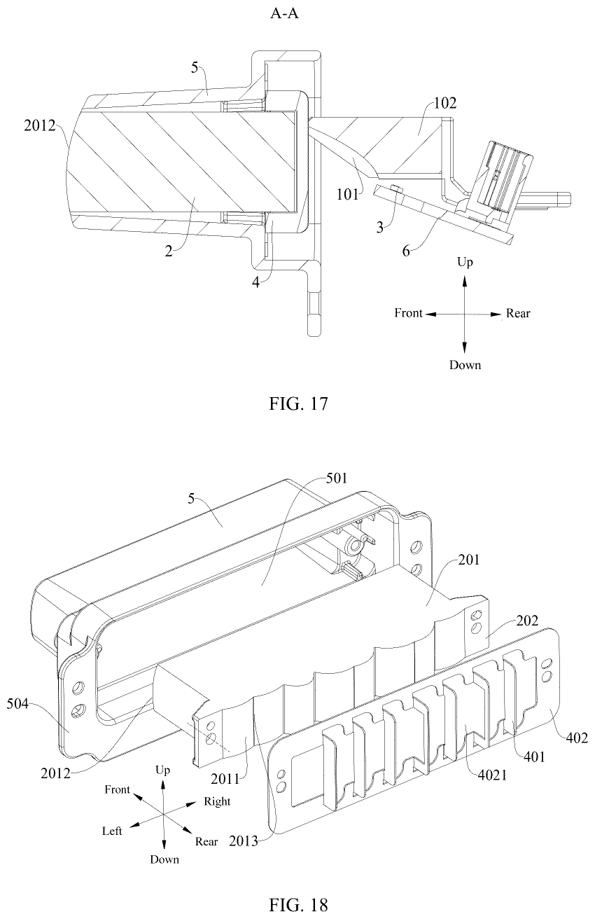

As illustrated in FIG. 1 to FIG. 6 and FIG. 15 to FIG. 17, the projection assembly 100 of embodiments of the present disclosure includes a plurality of optical units, and each optical unit includes a reflecting mirror 1 and a lens 2. The reflecting mirror I has a light reflecting surface 101, the lens 2 has a light incident surface 2011, and the light incident surface 2011 is arranged corresponding to the light reflecting surface 101. Each optical unit has an optical axis 110 extending along an X direction (a front-and-rear direction), the light reflecting surface 101 and the corresponding light incident surface 2011 are arranged along the X direction, and part of the plurality of optical units is an asymmetric unit. The asymmetric unit satisfies that a geometric centerline 111 of the light reflecting surface 101 and the optical axis 110 of a same asymmetric unit are spaced apart along a Y direction (a left-and-right direction), in other words, the optical axis 110 and the geometric centerline 111 of the light reflecting surface 101 of the asymmetric unit are staggered along the Y direction.

The optical unit also includes a light source 3, and light emitted by the light source 3 is reflected to the vicinity of a focal point of the light incident surface 2011 of the lens 2 through the light reflecting surface 101 of the reflecting mirror 1, and finally refracted to a road surface through the lens 2 to form a beam pattern, which is used for illumination. The beam pattern refracted by the lens 2 onto the road surface is essentially an image formed by the lens 2 projecting the illuminated reflective surface 101 of the reflecting mirror 1, which acts as an object, onto a front of the vehicle through the lens 2, the image is inverted in an up-and-down direction and the left-and-right direction. It may be understood that when the optical axis 110 of the optical unit intersects (coplanar) with the geometric centerline 111 of the light reflecting surface 101, the beam pattern formed by refracting the light emitted by the light source 3 to the road surface through the lens 2 is a left-right symmetrical beam pattern. When the optical axis 110 of the optical unit is spaced apart from the geometric centerline 111 of the light reflecting surface 101 along the Y direction (the left-and-right direction), the beam pattern formed by refracting the light emitted by the light source 3 to the road surface through the lens 2 is a left-right asymmetric beam pattern.

According to the projection assembly 100 of embodiments of the present disclosure, due to the optical axis 110 of the asymmetric unit and the geometric centerline 111 of the light reflecting surface 101 spaced apart along the Y direction, the beam pattern formed by the asymmetric unit is the left-right asymmetric beam pattern. Therefore, the energy of at least one of left and right sides of the beam pattern formed by the projection assembly 100 may be increased using the asymmetric unit. For example, when the geometric centerline 111 of the light reflecting surface 101 is provided at the right side of the optical axis 110 of the optical unit, the beam pattern formed by the asymmetric unit is shifted to the left, and the energy of the left side of the beam pattern formed by the projection assembly 100 may be increased using the asymmetric unit. Therefore, it may improve the energy uniformity of the beam pattern formed by the projection assembly 100 in a left-and-right direction, thereby improving the road illumination uniformity of the vehicle lamp 1000 with the projection assembly 100, and improving the driving safety.

Therefore, the projection assembly 100 of embodiments of the present disclosure has the advantages of forming the beam pattern with good energy uniformity in the left-and-right direction.

In some embodiments, the X direction and the Y direction mentioned above are consistent with a coordinate system of the vehicle provided with the projection assembly 100. In other words, the X direction and the Y direction mentioned above are an X direction and a Y direction of the coordinate system of the vehicle, respectively. The X direction is a front-and-rear direction of the vehicle, and the Y direction is the left-and-right direction of the vehicle. In other embodiments, the Y direction mentioned above may also refer to other directions, such as the Y direction being an up-and-down direction of the vehicle.

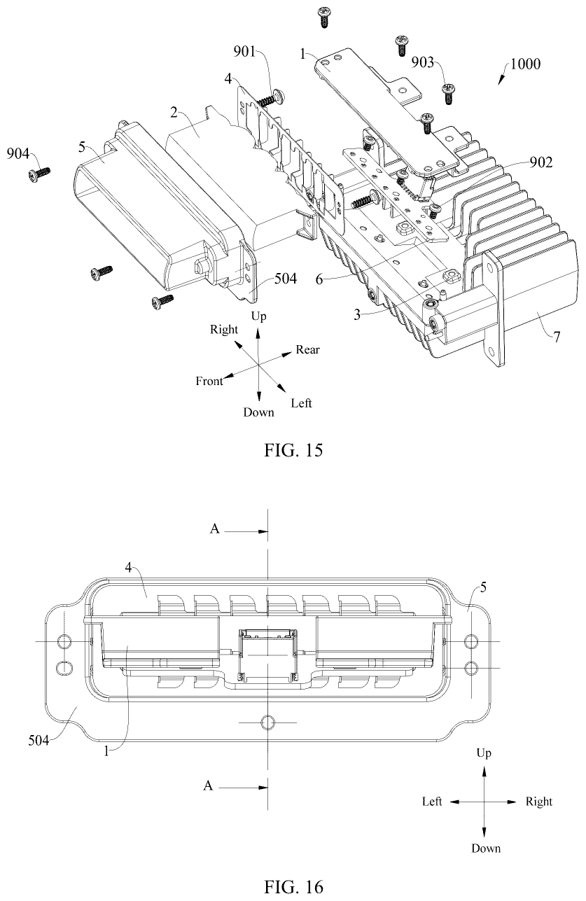

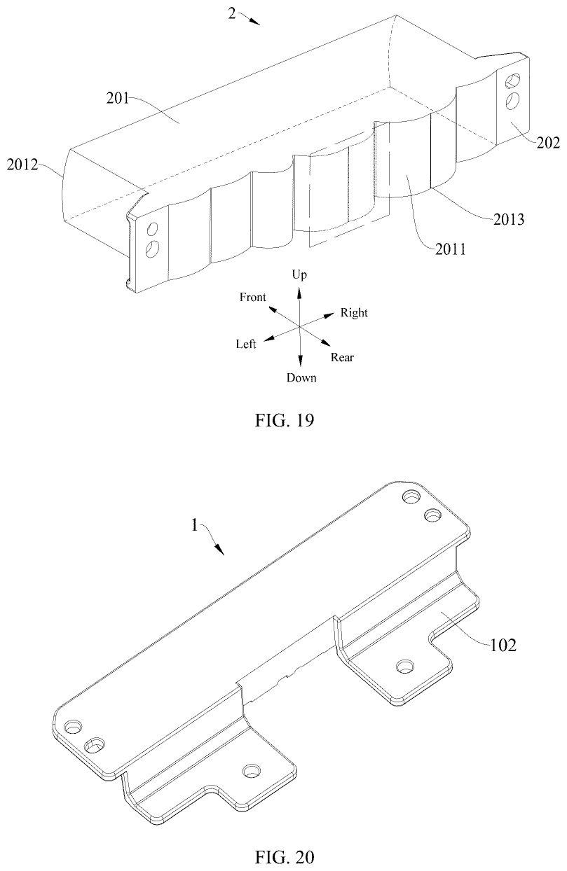

In some embodiments, as illustrated in FIG. 1, FIG. 15, and FIG. 19, the lens 2 has a light-exiting surface 2012 corresponding to the light incident surface 2011. The light incident surface 2011 is a light incident surface 2011 collimated in the Y direction, and the light-exiting surface 2012 is a light-exiting surface 2012 collimated in a Z direction.

It may be understood that the Z direction mentioned above is consistent with the coordinate system of the vehicle provided with the projection assembly 100. In other words, the Z direction mentioned above is a Z direction of the coordinate system of the vehicle. The Z direction is the up-and-down direction of the vehicle.

The light incident surface 2011 is the light incident surface 2011 collimated in the Y direction, which may be understood as: a section line of the light incident surface 2011 in the Y direction (the left-and-right direction) is a convex curve, and the light incident surface 2011 has a large degree of deflection to the light in the left-and-right direction, which may have a certain collimation effect on divergent light: a section line of the light incident surface 2011 in the Z direction (the up-and-down direction) is a straight line, and the light incident surface 2011 has a weak ability to deflect light in the up-and-down direction and does not have a collimation effect.

The light-emitting surface 2012 is the light-exiting surface 2012 collimated in the Z direction, which may be understood as: a section line of the light-emitting surface 2012 in the Z direction (the up-and-down direction) is a convex curve, and the light-emitting surface 2012 has a large degree of deflection in the up-and-down direction, which may have a certain degree of collimation effect on divergent light: a section line of the light-emitting surface 2012 in the Y direction (the left-and-right direction) is a straight line, and the light-emitting surface 2012 has a weak ability to deflect light in the left-and-right direction and does not have a collimation effect.

By setting the light incident surface 2011 of the lens 2 as the light incident surface 2011 with collimation in the Y direction and the light-exiting surface 2012 of the lens 2 as the light-exiting surface 2012 with collimation in the Z direction, it is convenient for the projection assembly 100 to form the asymmetric beam pattern on the road surface, for example, to form a rectangular beam pattern with large size in the left-and-right direction and small size in the up-and-down direction.

In some embodiments, the light incident surface 2011 and the light-exiting surface 2012 are spaced apart along the X direction.

For example, the light incident surface 2011 and the light-exiting surface 2012 are spaced apart along the front-and-rear direction.

In some embodiments, the light reflecting surface 101 is a parabolic surface.

By providing the light reflecting surface 101 as the parabolic surface, it is not only convenient for a design and processing of the reflecting mirror 1, but also the light reflecting surface 101 has a good reflective effect.

In other embodiments, the light reflecting surface 101 may also be of other surface types.

In some embodiments, a size of the light reflecting surface 101 in the Y direction is 5 mm˜15 mm.

For example, the size of the light reflecting surface 101 in the left-and-right direction is 10 mm.

In some embodiments, a focal length of the light reflecting surface 101 is 0.5 mm˜3 mm.

For example, the focal length of the light reflecting surface 101 is 1 mm, which makes the focal length of the light reflecting surface 101 smaller, which is beneficial for improving brightness and a light efficiency of the projection assembly 100 irradiated on the road surface.

In the related art, among the optical units of the projection assembly 100, part of the optical units is a main optical unit, which may form a main beam pattern with a light and dark cut-off line, while another part of the optical units is an auxiliary optical unit, and the auxiliary optical unit may only form an auxiliary beam pattern without the light and dark cut-off line. The main beam pattern has a horizontal line extending along the left-and-right direction, with a part of the main beam pattern located below the horizontal line and another part of the main beam pattern located above the horizontal line. Most or even entirety of the auxiliary beam pattern is located below the horizontal line. For example, a left part of the main beam pattern is located below the horizontal line, and a right part of the main beam pattern is located above the horizontal line: the auxiliary beam pattern is located below the horizontal line as a whole. As a result, energy on an upper right side of the beam pattern formed by the optical units of the projection assembly 100 is low; and the road illumination effect is poor.

In some embodiments, in the asymmetric unit, a first low-beam cut-off line 103 capable of forming a first light and dark cut-off line 112 is provided on a side of the light reflecting surface 101 away from the light incident surface 2011. The first low-beam cut-off line 103 has a first inflection point 113 capable of forming an “elbow” of the first light and dark cut-off line 112, and the first inflection point 113 is located on the optical axis 110 of the asymmetric unit.

By providing the first low-beam cut-off line 103 on the light reflecting surface 101 of the asymmetric unit, when the illuminated light reflecting surface 101 of the reflecting mirror 1, which acts as the object, is projected onto the front of the vehicle through the lens 2, the image (beam pattern) formed has a bright line that is consistent with the shape of the first low-beam cut-off line 103, and the bright line is the first light and dark cut-off line 112. The first low-beam cut-off line 103 is a polyline, and the first low-beam cut-off line includes a plurality of line segments coupled sequentially. A coupling point between adjacent line segments is an inflection point. There are adjacent first inflection point 113 and second inflection point 114 on the first low-beam cut-off line 103, the first inflection point 113 is located at a right side of the second inflection point 114, and the first inflection point 113 is higher than the second inflection point 114. When the light reflecting surface 101 of the reflecting mirror 1, which acts as the object, is projected onto the front of the vehicle through the lens 2, both an image of the first inflection point 113 and an image of the second inflection point 114 are located on the first light and dark cut-off line 112, and the image of the first inflection point 113 is located at a left side of the image of the second inflection point 114, and the image of the first inflection point 113 is lower than the image of the second inflection point 114. From the appearance, the image of the first inflection point 113 on the first light and dark cut-off line 112, which is similar to a human's “elbow”, is called as the “elbow” of the first light and dark cut-off line 112: the image of the second inflection point 114, which is similar to a human's “shoulder”, is called as the “shoulder” of the first light and dark cut-off line 112.

Through the above design of the asymmetric unit, a part of the light reflecting surface 101 located between the first inflection point 113 and the second inflection point 114 is projected onto the front of the vehicle through the lens 2, and the image (beam pattern) formed is located on the upper right side. As a result, the energy on the upper right side of the beam pattern formed by the asymmetric unit is relatively high. When the asymmetric unit serves as the auxiliary optical unit, the asymmetric unit may be used to increase the energy on the upper right side of the beam pattern formed by the projection assembly 100, thereby improving the road illumination effect of the vehicle lamp 1000 with the projection assembly 100, which is conducive to further improving the driving safety.

In some embodiments, a plurality of asymmetric units are provided, the plurality of asymmetric units are arranged along the Y direction, and two of the plurality of asymmetric units form an asymmetric unit group. The asymmetric unit group satisfies that the optical axis 110 of each asymmetric unit is located between the geometric centerline 111s of the two light reflecting surfaces 101 in the Y direction, i.e. the optical axis 110 of each asymmetric unit is located between the geometric centerline 111s of the two light reflecting surfaces 101 in the left-and-right direction.

For example, as illustrated in FIG. 4 to FIG. 6, in one asymmetric unit group, the two asymmetric units are a first asymmetric unit 801 and a second asymmetric unit 802, respectively, and the first asymmetric unit 801 is arranged at the left side of the second asymmetric unit 802. The reflecting mirror 1, the light source 3, and the lens 2 of the first asymmetric unit 801 are a first reflecting mirror 104, a first light source 301, and a first lens 203, respectively. The first reflecting mirror 104, the first light source 301, and the first lens 203 are arranged along the X direction. The reflecting mirror 1, the light source 3, and the lens 2 of the second asymmetric unit 802 are a second reflecting mirror 105, a second light source 302, and a second lens 204, respectively. The second reflecting mirror 105, the second light source 302, and the second lens 204 are arranged along the X direction. The light reflecting surface 101 of the first reflecting mirror 104 is a first light reflecting surface, the light reflecting surface 101 of the second reflecting mirror 105 is a second light reflecting surface, the optical axis 110 of the first asymmetric unit 801 is a first optical axis, and the optical axis 110 of the second asymmetric unit 802 is a second optical axis. The first optical axis is located at the right side of the geometric centerline 111 of the first light reflecting surface in the left-and-right direction, and the second optical axis is located at the left side of the geometric centerline 111 of the second light reflecting surface in the left-and-right direction, i.e. the first optical axis and the second optical axis are located between the geometric centerline 111 of the first light reflecting surface and the geometric centerline 111 of the second light reflecting surface in the left-and-right direction.

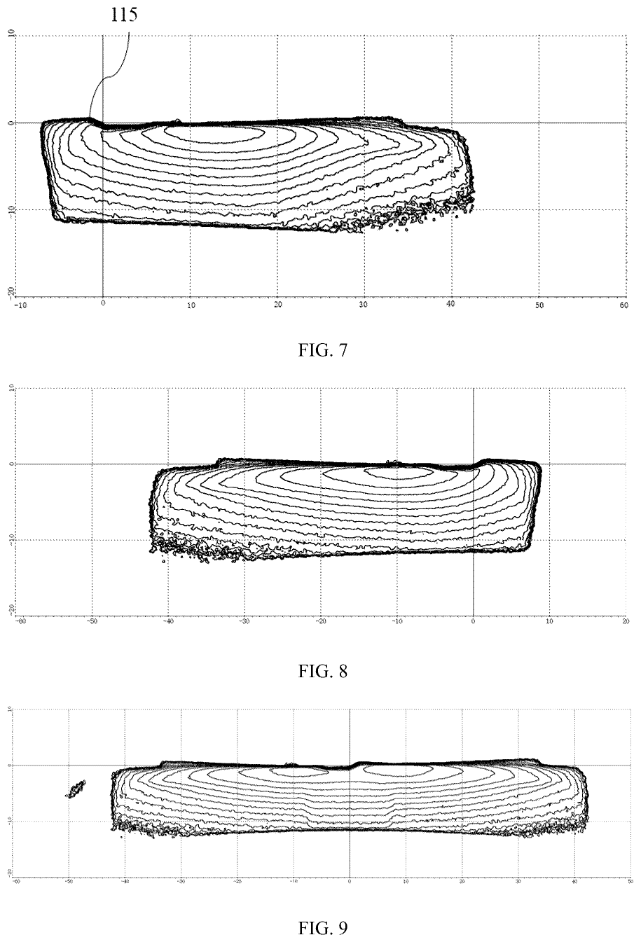

It may be understood that, as illustrated in FIG. 7, the beam pattern formed by the first asymmetric unit 801 arranged on the left side is shifted towards the right. As illustrated in FIG. 8, the beam pattern formed by the second asymmetric unit 802 arranged on the right side is shifted towards the left. As illustrated in FIG. 9, the first asymmetric unit 801 and the second asymmetric unit 802 jointly form the beam pattern with relatively high energy on both left side and right side.

By positioning the optical axis 110 of each asymmetric unit between the geometric centerline 111s of the two light reflecting surfaces 101 in the left-and-right direction, the energy of the beam pattern formed by the asymmetric unit group on both left side and right side is relatively high, which is conducive to improving the energy uniformity of the beam pattern formed by the projection assembly 100 in the left-and-right direction, which may further improve the road illumination uniformity of the vehicle lamp 1000 with the projection assembly 100 and improve the driving safety.

In some embodiments, a distance between the optical axis 110 and the geometric centerline 111 of the light reflecting surface 101 in the first asymmetric unit 801 is L1, and a distance between the optical axis 110 and the geometric centerline 111 of the light reflecting surface 101 in the second asymmetric unit 802 is L2. L1 is equal to L2 or L1 is greater than L2.

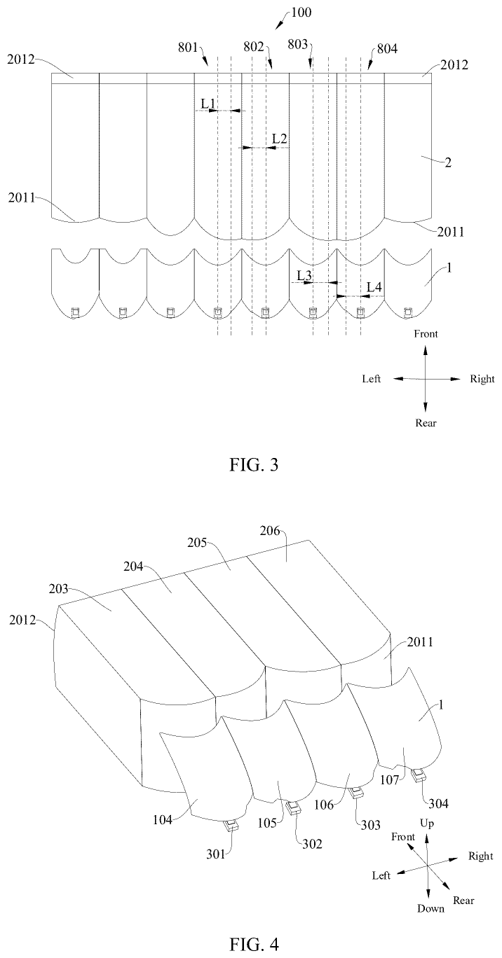

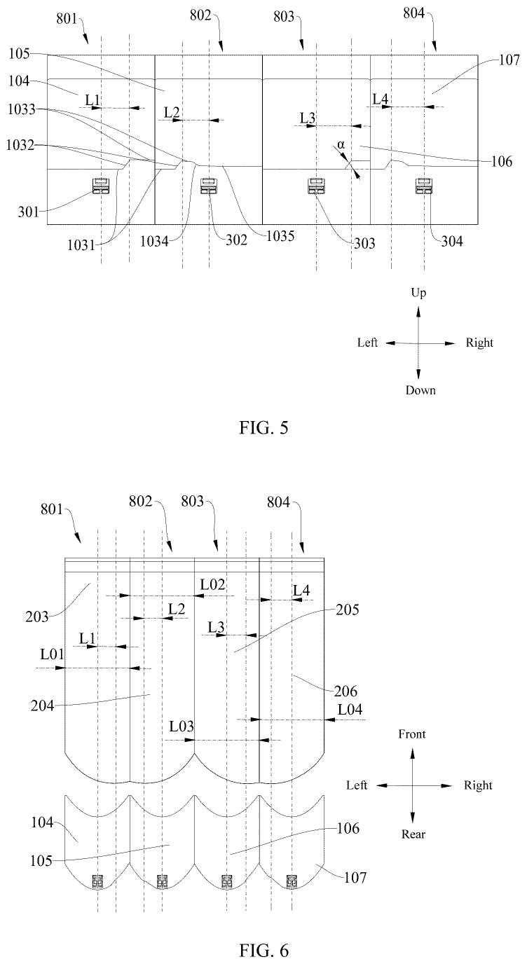

For example, as illustrated in FIG. 2, FIG. 3, FIG. 5, and FIG. 6, the distance between the geometric centerline 111 of the first light reflecting surface and the optical axis 110 of the first asymmetric unit 801 is L1, the distance between the geometric centerline 111 of the second light reflecting surface and the optical axis 110 of the second asymmetric unit 802 is L2, and L1 is equal to L2. Furthermore, it may be understood that when the light incident surface 2011 of the first lens 203 is the same as the light incident surface 2011 of the second lens 204, the first lens 203 and the second lens 204 are symmetrically arranged in the left-and-right direction.

By setting L1 and L2 as equal, on the one hand, some components of the first asymmetric unit 801 and the second asymmetric unit 802 may be identical or symmetrical, thereby facilitating the processing and manufacturing of the asymmetric unit group, and thus facilitating the processing and manufacturing of the projection assembly 100: on the other hand, L1 and L2 are equal, so that the beam pattern formed by the two asymmetric units in the asymmetric unit group is left-right symmetrical (excluding the low-beam cut-off line part), which facilitates the beam pattern formed by the projection assembly 100 with the balanced energy on the left and right sides, and is conducive to further improving the road illumination uniformity of the vehicle lamp 1000 with the projection assembly 100.

In addition, when L1 is greater than L2, the beam pattern formed by the two asymmetric units in the asymmetric unit group is left-right asymmetric, which is convenient to adjust a size of L1 and L2 according to requirements of the road illumination, so that one of the left and right sides of the beam pattern formed by the projection assembly 100 has higher energy, which is conducive to further improving the road illumination effect of the vehicle lamp 1000 with the projection assembly 100.

In some embodiments, a size of the light reflecting surface 101 of the first asymmetric unit in the Y direction is L01, and a size of the light reflecting surface 101 of the second asymmetric unit in the Y direction is L02. A ratio of L1 to L01 is 0.05˜0.49, and/or a ratio of L2 to L02 is 0.05˜0.49.

For example, as illustrated in FIG. 2, FIG. 3, FIG. 5, and FIG. 6, the size of the first light reflecting surface in the left-and-right direction in the first asymmetric unit 801 is L01, and the size of the second light reflecting surface in the left-and-right direction in the second asymmetric unit 802 is L02. The ratio of L1 to L01 in the first asymmetric unit 801 is 0.26, and the ratio of L2 to L0 in the second asymmetric unit 802 is 0.26. In this case, as illustrated in FIG. 7, the part with large energy of the beam pattern formed by the first asymmetric unit 801 is located in a the range of 5°˜15°, as illustrated in FIG. 8, the part with large energy of the beam pattern formed by the second asymmetric unit 802 is located in a the range of −5°˜−15°.

By setting the ratio of L1 to L01 as 0.05-0.49 and the ratio of L2 to L02 as 0.05-0.49, the part with large energy of the first asymmetric unit 801 and the second asymmetric unit 802 is located within a commonly used angle range for a driver, which is conducive to further improving the road illumination effect of the vehicle lamp 1000 with the projection assembly 100.

In some embodiments, L1 is equal to L2, and L01 is equal to L02.

In some embodiments, a plurality of asymmetric unit groups are provided, and the plurality of asymmetric unit groups are arranged along the Y direction.

For example, as illustrated in FIG. 2, FIG. 3, FIG. 5, and FIG. 6, the number of the asymmetric unit groups is two, and the two asymmetric unit groups are arranged in the left-and-right direction. The number of asymmetric unit groups may also be three or more.

By providing the plurality of asymmetric unit groups, on the one hand, the plurality of asymmetric unit groups may be provided as different as needed, so that it is convenient to make the energy of various parts of the left and right sides of the beam pattern formed by the projection assembly 100 higher, which is conducive to further improving the road illumination effect; on the other hand, at least two asymmetric unit groups may be provided to be the same as needed, so that the energy of a certain part of the left and right sides of the beam pattern formed by the projection assembly 100 may be set larger, which is conducive to further improving the road illumination effect.

In some embodiments, at least one of the asymmetric unit groups is a first asymmetric unit group, and at least one of the asymmetric unit groups is a second asymmetric unit group. In the first asymmetric unit group, one of the asymmetric units is the first asymmetric unit 801, and the other asymmetric unit is the second asymmetric unit 802. The distance between the optical axis 110 and the geometric centerline 111 of the corresponding light reflecting surface 101 in the first asymmetric unit 801 is L1, and the distance between the optical axis 110 and the geometric centerline 111 of the corresponding light reflecting surface 101 in the second asymmetric unit 802 is L2. In the second asymmetric unit group, one of the asymmetric units is a third asymmetric unit 803, and the other asymmetric unit is a fourth asymmetric unit 804. The distance between the geometric centerline 111 of the light reflecting surface 101 and the optical axis 110 in the third asymmetric unit 803 is L3, and the distance between the optical axis 110 and the geometric centerline 111 of the corresponding light reflecting surface 101 in the fourth asymmetric unit 804 is L4.

L1 is equal to L2, L3 is equal to L4, and L3 is greater than L1; or L1 is greater than L2, and L3 is greater than L4; or, L1 is equal to L2, and L3 is greater than L4. In other words, L1 and L2 may be equal or unequal, and L3 and L4 may be equal or unequal.

For example, as illustrated in FIG. 2, FIG. 3, FIG. 5, and FIG. 6, the third asymmetric unit 803 is located at the left side of the fourth asymmetric unit 804. The reflecting mirror 1, the light source 3, and the lens 2 of the third asymmetric unit 803 are a third reflecting mirror 106, a third light source 303, and the third lens 205, respectively. The third reflecting mirror 106, the third light source 303, and the third lens 205 are arranged along the X direction. The reflecting mirror 1, the light source 3, and the lens 2 of the fourth asymmetric unit 804 are a fourth reflecting mirror 107, a fourth light source 304, and a fourth lens 206, respectively. The fourth reflecting mirror 107, the fourth light source 304, and the fourth lens 206 are arranged in the X direction. The light reflecting surface 101 of the third reflecting mirror 106 is a third light reflecting surface, the light reflecting surface 101 of the fourth reflecting mirror 107 is a fourth light reflecting surface, the optical axis 110 of the third asymmetric unit 803 is a third optical axis, and the optical axis 110 of the fourth asymmetric unit 804 is a fourth optical axis. The third optical axis is located at the right side of the geometric centerline 111 of the third light reflecting surface in the left-and-right direction, and the fourth optical axis is located at the left side of the geometric centerline 111 of the fourth light reflecting surface in the left-and-right direction, i.e. the third optical axis and the fourth optical axis are located between the geometric centerline 111 of the third light reflecting surface and the geometric centerline 111 of the fourth light reflecting surface in the left-and-right direction.

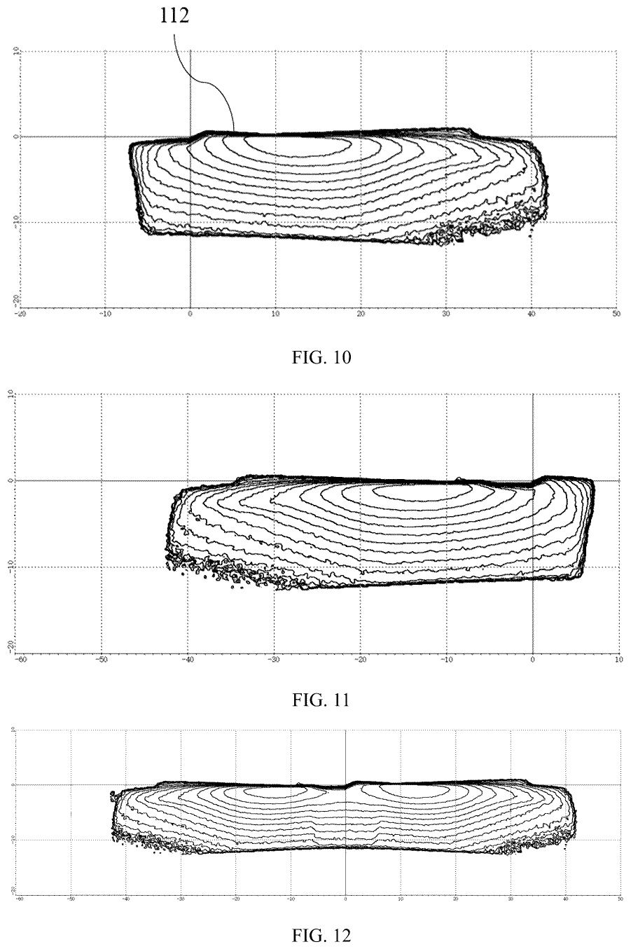

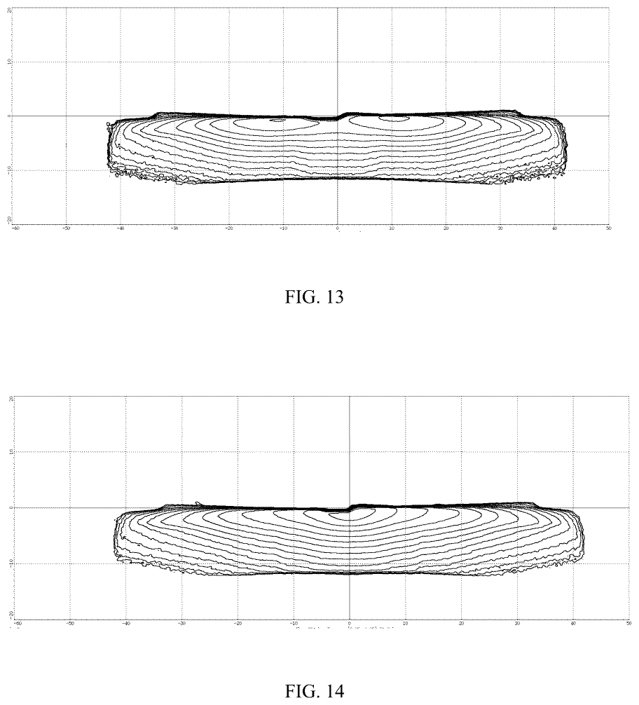

In the first asymmetric unit group. L1 is equal to L2, and in the second asymmetric unit group, L3 is equal to L4, and L3 is greater than L1. In this case, as illustrated in FIG. 7 to FIG. 9. the beam pattern formed by the first asymmetric unit 801 and the second asymmetric unit 802 in the first asymmetric unit group is left-right symmetrical (excluding the low-beam cut-off line part): as illustrated in FIG. 10 to FIG. 12, the beam pattern formed by the third asymmetric unit 803 and the fourth asymmetric unit 804 in the second asymmetric unit group is left-right symmetrical (excluding the low-beam cut-off line part): and an angle of the part with large energy of the beam pattern formed by the second asymmetric unit group is different from that of the part with large energy of the beam pattern formed by the first asymmetric unit group. For example, the part with large energy of the beam pattern formed by the second asymmetric unit group is located at 8°˜18° and −8°˜−18°, while the part with large energy of the beam pattern formed by the first asymmetric unit group is located at 5°˜15° and −5°˜−15°. Therefore, as illustrated in FIG. 13, the part with large energy of the beam pattern formed by the first asymmetric unit group and the second asymmetric unit group is located at 4°˜19° and −4°˜−19°, which is convenient to make the energy of various parts of the left and right sides of the beam pattern formed by the projection assembly 100 higher, which is conducive to further improving the road illumination effect.

In some embodiments, the size of the light reflecting surface 101 of the first asymmetric unit in the Y direction is L01, the size of the light reflecting surface 101 of the second asymmetric unit in the Y direction is L02, the size of the light reflecting surface 101 of the third asymmetric unit in the Y direction is L03, and the size of the light reflecting surface 101 of the fourth asymmetric unit in the Y direction is L04.

A ratio of L1 to L01 is 0.05˜0.35, and/or a ratio of L2 to L02 is 0.05˜0.35, and/or a ratio of L3 to L03 is 0.1˜0.49, and/or a ratio of L4 to L04 is 0.1˜0.49. In other words, the ratio of L1 to L01 is 0.05˜0.35, the ratio of L2 to L02 is 0.05˜0.35, the ratio of L3 to L03 is 0.1˜0.49, and the ratio of L4 to L04 is 0.1˜0.49; or, one of the ratio of L1 to L01 and the ratio of L2 to L02 is 0 0.05˜0.35; or, one of the ratio of L3 to L03 and the radio of L4 to L04 is 0.1˜0.49; or, one of the ratio of L1 to L01 and the ratio of L2 to L02 is 0 0.05˜0.35, and one of the ratio of L3 to L03 and the radio of L4 to L04 is 0.1˜0.49.

For example, the ratio of L1 to L01 in the first asymmetric unit 801 is 0.26; the ratio of L2 to L02 in the second asymmetric unit 802 is 0.26, the ratio of L3 to L03 in the third asymmetric unit 803 is 0.314, and the ratio of L4 to L04 in the fourth asymmetric unit 804 is 0.314. In this case, as illustrated in FIG. 7, the part with large energy of the beam pattern formed by the first asymmetric unit 801 is located at 5°˜15°. As illustrated in FIG. 8, the part with large energy of the beam pattern formed by the second asymmetric unit 802 is located at −5°˜−15°. As illustrated in FIG. 10, the part with large energy of the beam pattern formed by the third asymmetric unit 803 is located at 8°˜18°. As illustrated in FIG. 11, the part with large energy of the beam pattern formed by the fourth asymmetric unit 804 is located at −8°˜−18°. Therefore, as illustrated in FIG. 13, the part with large energy of the beam pattern formed by the first asymmetric unit group and the second asymmetric unit group is located at 4°˜19° and −4°˜−19°.

By setting the ratio of L1 to L01, the ratio of L2 to L02, the ratio of L3 to L03, and the ratio of L4 to L04 mentioned above, the part with large energy of the first asymmetric unit group and the second asymmetric unit group is located within the commonly used angle range for the driver, which is conducive to further improving the road illumination effect of the vehicle lamp 1000 with the projection assembly 100.

In some embodiments, the two asymmetric units in the asymmetric unit group are arranged adjacent to each other.

For example, as illustrated in FIG. 4 to FIG. 6, the first asymmetric unit 801 and the second asymmetric unit 802 in the first asymmetric unit group are arranged adjacent to each other, and the third asymmetric unit 803 and the fourth asymmetric unit 804 in the second asymmetric unit group are arranged adjacent to each other.

By processing two adjacent asymmetric units in the asymmetric unit group arranged adjacent to each other, when designing and assembling the projection assembly 100, the asymmetric unit group may be treated as a whole, which facilitates the design and assembly of the projection assembly 100.

In some embodiments, in the asymmetric unit group, the light incident surfaces 2011 of the two asymmetric units are symmetrically arranged in the Y direction.

For example, as illustrated in FIG. 1 to FIG. 6, in the first asymmetric unit group, the light incident surface 2011 of the first lens 203 and the light incident surface 2011 of the second lens 204 are provided left-right symmetrically. In the second asymmetric unit group, the light incident surface 2011 of the third lens 205 and the light incident surface 2011 of the fourth lens 206 are provided left-right symmetrically.

By symmetrically providing the light incident surfaces 2011 of the lenses 2 of the two asymmetric units in the asymmetric unit group in the Y direction, the design and processing of the lens 2 is facilitated.

In some embodiments, as illustrated in FIG. 19, the light incident surface 2011 of the first lens 203 and the light incident surface 2011 of the second lens 204 are tangent to a same plane, which is perpendicular to the X direction.

In some embodiments, the first low-beam cut-off line 103 includes a first segment 1031, a second segment 1032, and a third segment 1033 coupled sequentially along the Y direction. The first segment 1031 and the third segment 1033 are spaced apart in the Z direction, and the second segment 1032 is inclined. The second inflection point 114 is formed between the first segment 1031 and the second segment 1032, and the first inflection point 113 is formed between the third segment 1033 and the second segment 1032. The first inflection point 113 may form the “elbow” of the first light and dark cut-off line 112, and the second inflection point 114 may form the “shoulder” of the first light and dark cut-off line 112.

For example, as illustrated in FIG. 5, the first low-beam cut-off line 103 includes the first segment 1031, the second segment 1032, and the third segment 1033 coupled sequentially from left to right. The first segment 1031 is located below the third segment 1033, and a left end of the second segment 1032 is lower and a right end of the second segment 1032 is higher. The coupling point between the first segment 1031 and the second segment 1032 forms the second inflection point 114, while the coupling point between the third segment 1033 and the second segment 1032 forms the first inflection point 113. Specifically, taking the first asymmetric unit as an example, as illustrated in FIG. 7, the first asymmetric unit 801 may form the beam pattern with the first light and dark cut-off line 112, the first inflection point 113 of the first reflecting mirror 104 may form the “elbow” of the first light and dark cut-off line 112, and the second inflection point 114 of the first reflecting mirror 104 may form the “shoulder” of the first light and dark cut-off line 112.

In some embodiments, an inclination angle of the second segment 1032 is 45°.

For example, as illustrated in FIG. 5, the inclination angle α of the second segment 1032 is 45°.

In some embodiments, at least one of the first segment 1031, the second segment 1032, and the third segment 1033 is a straight line.

For example, the first segment 1031, the second segment 1032, and the third segment 1033 are all straight lines. In this case, the first segment 1031, the second segment 1032, and the third segment 1033 form a polyline.

It may be understood that when the first segment 1031 and the third segment 1033 are straight lines, the first segment 1031 and the third segment 1033 may be straight lines parallel to the left-and-right direction or oblique lines intersecting with the left-and-right direction.

In some embodiments, at least one of the first segment 1031, second segment 1032, and third segment 1033 is a curve.

For example, the first segment 1031 and the third segment 1033 are straight lines, and the second segment 1032 is a curve.

In some embodiments, the first low-beam cut-off line 103 further includes a fourth segment 1034 and a fifth segment 1035, the third segment 1033, the fourth segment 1034, and the fifth segment 1035 are coupled sequentially along the Y direction. The third segment 1033 and the fifth segment 1035 are spaced apart in the Z direction, the fourth segment 1034 is inclined, and the fourth segment 1034 is located between the first segment 1031 and the third segment 1033 in the Z direction.

For example, as illustrated in FIG. 5, the first low-beam cut-off line 103 also includes the fourth segment 1034 and the fifth segment 1035. The third segment 1033, the fourth segment 1034, and the fifth segment 1035 are coupled sequentially from left to right. The third segment 1033 is located below the fifth segment 1035, a left end of the fourth segment 1034 is higher and a right end of the fourth segment 1034 is lower, and the fourth segment 1034 is located between the first segment 1031 and the third segment 1033 in the up-and-down direction.

Therefore, as illustrated in FIG. 8, by providing the fourth segment 1034 and the fifth segment 1035 on the right side of the third segment 1033, and the third segment 1033 and the fifth segment 1035 spaced apart in the up-and-down direction, a left side part of the beam pattern formed by the asymmetric unit is located on an upper side of the horizontal line, so that a left side of the vehicle has a better road illumination effect in the case of avoiding the low beam lamp from shining to an opposite driver's driving position.

In some embodiments, at least one of the fourth segment 1034 and the fifth segment 1035 is a straight line.

For example, the fourth segment 1034 and the fifth segment 1035 are both straight lines. It may be understood that when the fifth segment 1035 is the straight line, it may be the straight line parallel to the left-and-right direction or the oblique line intersecting with the left-and-right direction.

In some embodiments, at least one of the fourth segment 1034 and the fifth segment 1035 is a curve.

For example, the fourth segment 1034 and the fifth segment 1035 are both curves.

In some embodiments, another part of the plurality of optical units is a symmetrical unit, and the symmetrical unit satisfies that the optical axis 110 of the symmetrical unit intersects with the geometric centerline 111 of the light reflecting surface 101.

For example, in the symmetrical unit, the optical axis 110 and the geometric centerline 111 of the light reflecting surface 101 of the symmetrical unit are located on a same plane perpendicular to the left-and-right direction, and the geometric centerline 111 of the light reflecting surface 101 intersects with the optical axis 110 of the symmetrical unit.

According to the projection assembly of embodiments of the present disclosure, due to the geometric centerline 111 of the light reflecting surface 101 intersecting with the optical axis 110 of the symmetrical unit, the beam pattern formed by the symmetrical unit is a left-right symmetrical beam pattern. Therefore, by combining the asymmetric unit with the symmetric unit, the energy in the middle and the energy of at least one of left and right sides of the beam pattern formed by the projection assembly 100 may be relatively high, resulting in the better energy uniformity of the beam pattern formed by the projection assembly 100 in the left-and-right direction.

In some embodiments, a plurality of symmetrical units are provided, and in at least one of the symmetrical units, a second low-beam cut-off line 108 capable of forming a second light and dark cut-off line 115 is provided at one end of the light reflecting surface 101 away from the light incident surface 2011. The second low-beam cut-off line 108 has a third inflection point 116 capable of forming an elbow of the second light and dark cut-off line 115, and the third inflection point 116 is provided on the optical axis 110 of the symmetrical unit.

Similar to the first low-beam cut-off line 103, the second low-beam cut-off line 108 is a polyline, the second low-beam cut-off line 108 may form the second light and dark cut-off line 115, and the third inflection point 116 may form the “elbow” of the second light and dark cut-off line 115. By providing the second low-beam cut-off line 108 on the light reflecting surface 101 of the symmetrical unit, when using the projection assembly 100 to achieve illumination, the beam pattern formed by the symmetrical unit not only has left-right symmetry, but also has the second light and dark cut-off line 115. Therefore, the symmetrical unit may serve as the main optical unit, and the beam pattern formed by the main optical unit is the main beam pattern. Therefore, the energy of the beam pattern formed by the symmetrical unit with the second low-beam cut-off line 108 and the asymmetrical unit in a superimposed manner is more uniform on both left and right sides, which may further improve the road illumination effect of the vehicle lamp 1000 with the projection assembly 100, and is conducive to further improving the driving safety.

It may be understood that the first light and dark cut-off line 112 formed by the asymmetric unit overlaps the second light and dark cut-off line 115 formed by the symmetric unit, forming a light and dark cut-off line of the vehicle lamp 1000 with the projection assembly 100. The plurality of symmetric units may have only one symmetric unit with the second low-beam cut-off line 108, or two or more symmetric units with the second low-beam cut-off line 108.

In some embodiments, the light source 3, the light reflecting surface 101, and the light incident surface 2011 correspond one-to-one and form one optical unit.

In some embodiments, the light source 3 is a surface light source, and the number of the light sources 3 is 5˜10.

For example, as illustrated in FIG. 1 to FIG. 3, the number of the light sources 3 is 8. In one embodiment, the light source 3 is an LED.

In some embodiments, the plurality of lenses 2 form a one-piece structure, and a separation part 2013 is formed between the light incident surfaces 2011 of adjacent lenses 2.

For example, as illustrated in FIG. 15 to FIG. 18, eight lenses 2 form the one-piece structure, and eight lenses 2 form a lens group. The eight light incident surfaces 2011 of the lens group are sequentially coupled to form a wavy surface. The eight light-emitting surfaces 2012 of the lens group are sequentially coupled to form a convex surface.

In some embodiments, the plurality of reflecting mirrors 1 form a one-piece structure.

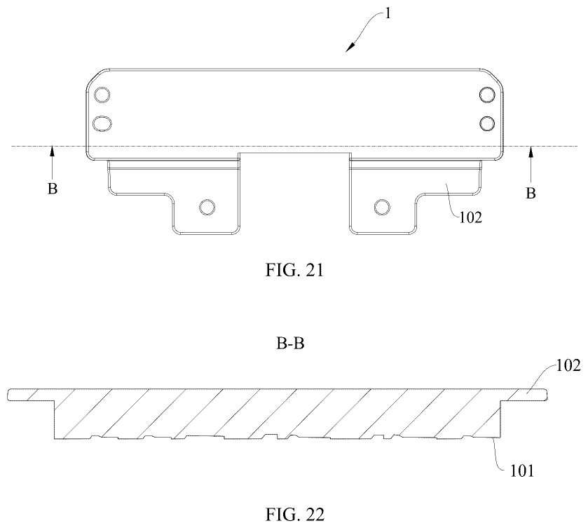

For example, as illustrated in FIG. 14, FIG. 20 to FIG. 22, eight reflecting mirrors 1 form a reflecting mirror group.

In some embodiments, the reflecting mirror 1 includes a reflecting part and a fixing part 102, the reflecting part and the fixing part 102 have the one-piece structure, and the light reflecting surface 101 is provided on the reflecting part.

The vehicle lamp 1000 of embodiments of the present disclosure includes the projection assembly 100 as described in any of the above embodiments.

Therefore, the vehicle lamp 1000 of embodiments of the present disclosure has the advantage of the good road illumination uniformity.

In the related art, the beam pattern formed by the vehicle lamp 1000 on the road surface exhibits a stray light phenomenon, which affects the road illumination effect of the vehicle lamp 1000.

The vehicle lamp 1000 of embodiments of the present disclosure further includes a light-blocking member 4, which includes a light-blocking part 401. The light-blocking part 401 is provided between two adjacent light incident surfaces 2011, i.e. the light-blocking part 401 corresponds to the separation part 2013 to separate the two adjacent light incident surfaces 2011.

According to the vehicle lamp 1000 of embodiments of the present disclosure, by providing the light-blocking member 4, the two adjacent light incident surfaces 2011 are separated by light-blocking part 401 of the light-blocking member 4, which may effectively prevent the light emitted by the light source 3 from shining on the light incident surface 2011 of the adjacent optical unit and forming stray light. When the vehicle lamp 1000 with embodiments of the present disclosure operates, it may greatly reduce or even avoid stray light, which is beneficial for improving the road illumination effect of the vehicle lamp 1000.

Therefore, the vehicle lamp 1000 with embodiments of the present disclosure has the advantage of the good road illumination effect.

In some embodiments, as illustrated in FIG. 15 to FIG. 18, there are a plurality of light-blocking parts 401, and the light-blocking parts 401 is provided between any two adjacent light incident surfaces 2011.

By providing the light-blocking part 401 between any two adjacent light incident surfaces 2011, it is possible to effectively prevent the light emitted by any one light source 3 from shining on the light incident surface 2011 of the adjacent optical unit and forming stray light, which further improves the road illumination effect of the vehicle lamp 1000.

In some embodiments, as illustrated in FIG. 15 and FIG. 18, the light-blocking member 4 further includes a coupling part 402, the plurality of light-blocking parts 401 are coupled to the coupling part 402, and the coupling part 402 is coupled to the lens 2.

When assembling the vehicle lamp 1000, the coupling part 402 may be used to couple the light-blocking member 4 to the lens 2, forming a first sub assembly. Then, the first sub assembly may be coupled to other components, facilitating fixation of the light-blocking member 4 at a preset position of the lens 2.

Therefore, by providing the coupling part 402 on the light-blocking member 4, the coupling part 402 is coupled to the lens 2, which not only facilitates the assembly of the vehicle lamp 1000, but also may effectively improve an assembly accuracy between the light-blocking part 401 and the light incident surface 2011, which is conducive to further improving the road illumination effect of the vehicle lamp 1000.

In some embodiments, the coupling part 402 and the light-blocking part 401 form an one-piece structure.

In some embodiments, the light-blocking member 4 is a stainless steel member, a plastic member, or an aluminum alloy member.

In some embodiments, the light-blocking part 401 is a light-blocking panel or a light-blocking strip.

In some embodiments, the coupling part 402 is the coupling panel, the coupling panel has an avoidance part 4021 for avoiding the light incident surface 2011, and the avoidance part 4021 may be an avoidance hole or an avoidance groove.

In some embodiments, the vehicle lamp 1000 further includes a frame 5, and the coupling part 402 and the lens 2 are both coupled to the frame 5.

For example, as illustrated in FIG. 15 to FIG. 18, the frame 5 is a cover with an accommodating chamber 501, the lens 2 is arranged inside the accommodating chamber 501, and the light-blocking member 4 is arranged inside the accommodating chamber 501. The lens 2 includes a lens body 201 and a coupling arm 202, and the light incident surface 2011 and the light-exiting surface 2012 are arranged on the lens body 201.

The frame 5 has a first coupling hole, the coupling arm 202 has a second coupling hole, the coupling part 402 has a third coupling hole, and the vehicle lamp 1000 also includes a first fastener 901. The first fastener 901 passes through the third coupling hole and the second coupling hole and is coupled to the first coupling hole. The first fastener is used to realize the coupling between the light-blocking member 4, the lens 2, and the frame 5.

In some embodiments, the first fastener 901 be a bolt, a screw; etc.

In some embodiments, as illustrated in FIG. 15, the vehicle lamp 1000 further comprises a PCB panel 6 and a radiator 7. The light source 3 is provided on the PCB panel 6, and the PCB panel 6 is coupled to the radiator 7 through a second fastener 902. The fixing part 102 is coupled to the radiator 7 through a third fastener 903.

In some embodiments, as illustrated in FIG. 15, FIG. 16, and FIG. 18, the frame 5 has a flange 504, and the radiator 7 is coupled to the flange 504 through a fourth fastener 904.

The second fastener 902, the third fastener 903, and the fourth fastener 904 may be bolts, screws, etc.

When assembling the vehicle lamp 1000, the lens 2, the light-blocking member 4, and the frame 5 are assembled into the first sub assembly, and the reflecting mirror 1, the light source 3, the PCB panel 6, and the radiator 7 are assembled into a second sub assembly. Then, the second sub assembly is coupled to the first sub assembly through the fourth fastener 904.

The vehicle of embodiments of the present disclosure includes the vehicle lamp 1000 as described in any of the above embodiments.

Therefore, the vehicle of embodiments of the present disclosure has the advantage of good safety.

A projection assembly of embodiments of the present disclosure includes a plurality of optical units, and each optical unit includes a reflecting mirror and a lens. The reflecting mirror has a light reflecting surface, the lens has a light incident surface, and the light incident surface is arranged corresponding to the light reflecting surface. Each optical unit has an optical axis extending along an X direction, and the light reflecting surface and the corresponding light incident surface are arranged along the X direction. Part of the plurality of optical units is an asymmetric units, and the asymmetric unit satisfies that the optical axis and a geometric centerline of the light reflecting surface are spaced apart along a Y direction in a same asymmetric unit.

In some embodiments, in the asymmetric unit, a first low-beam cut-off line capable of forming a first light and dark cut-off line is provided on a side of the light reflecting surface away from the light incident surface, the first low-beam cut-off line has a first inflection point capable of forming an elbow of the first light and dark cut-off line, and the first inflection point is provided on the optical axis of the asymmetric unit.

In some embodiments, a plurality of asymmetric units are provided, the plurality of asymmetric units are arranged along the Y direction, two asymmetric units of the plurality of asymmetric units form an asymmetric unit group, and the asymmetric unit group satisfies that the optical axis of each asymmetric unit is located between the geometric centerlines of two light reflecting surfaces in the Y direction.

In some embodiments, in the asymmetric unit group, one of the asymmetric units is a first asymmetric unit, the other asymmetric unit is a second asymmetric unit, a distance between the optical axis and the geometric centerline of the light reflecting surface in the first asymmetric unit is L1, and a distance between the optical axis and the geometric centerline of the light reflecting surface in the second asymmetric unit is L2, in which L1 is equal to L2 or L1 is greater than L2.

In some embodiments, a size of the light reflecting surface of the first asymmetric unit in the Y direction is L01, and a size of the light reflecting surface of the second asymmetric unit in the Y direction is L02, in which a ratio of L1 to L01 is 0.05˜0.49, and/or a ratio of L2 to L02 is 0.05˜0.49.

In some embodiments, a plurality of asymmetric unit groups are provided, and the plurality of asymmetric unit groups are arranged along the Y direction.

In some embodiments, at least one of the asymmetric unit groups is a first asymmetric unit group, and at least one of the asymmetric unit groups is a second asymmetric unit group, in which in the first asymmetric unit group, one of the asymmetric units is a first asymmetric unit, the other asymmetric unit is a second asymmetric unit, a distance between the optical axis and the geometric centerline of the light reflecting surface in the first asymmetric unit is L1, and a distance between the optical axis and the geometric centerline of the light reflecting surface in the second asymmetric unit is L2. In the second asymmetric unit group, one of the asymmetric units is a third asymmetric unit, and the other asymmetric unit is a fourth asymmetric unit, a distance between the optical axis and the geometric centerline of the light reflecting surface in the third asymmetric unit is L3, and a distance between the optical axis and the geometric centerline of the light reflecting surface in the fourth asymmetric unit is L4. L1 is equal to L2, L3 is equal to L4, and L3 is greater than L1, or L1 is greater than L2, L3 is greater than L4, or L1 is equal to L2, and L3 is greater than L4.

In some embodiments, a size of the light reflecting surface of the first asymmetric unit in the Y direction is L01, a size of the light reflecting surface of the second asymmetric unit in the Y direction is L02, a size of the light reflecting surface of the third asymmetric unit in the Y direction is L03, and a size of the light reflecting surface of the fourth asymmetric unit in the Y direction is L04: a ratio of L1 to L01 is 0.05˜0.35, and/or a ratio of L2 to L02 is 0.05˜0.35, and/or a ratio of L3 to L03 is 0.1˜0.49, and/or a ratio of L4 to L04 is 0.1˜0.49.

In some embodiments, two asymmetric units in the asymmetric unit group are arranged adjacent to each other.

In some embodiments, in the asymmetric unit group, the light incident surfaces of the two asymmetric units are symmetrically arranged in the Y direction.

In some embodiments, the first low-beam cut-off line includes a first segment, a second segment, and a third segment sequentially coupled along the Y direction, the first segment and the third segment are spaced apart in a Z direction, the second segment is inclined, a joint between the third segment and the second segment forms the first inflection point, a joint between the first segment and the second segment forms a second inflection point, and the second inflection point is capable of forming a shoulder of the first light and dark cut-off line: an inclination angle of the second segment is 45°, and/or at least one of the first segment, the second segment, and the third segment is a straight line, and/or at least one of the first segment, the second segment, and the third segment is a curve.

In some embodiments, the first low-beam cut-off line further includes a fourth segment and a fifth segment, the third segment, the fourth segment, and the fifth segment are coupled sequentially along the Y direction, the third segment and the fifth segment are spaced apart in the Z direction, the fourth segment is inclined, and the fourth segment is located between the first segment and the third segment in the Z direction.

In some embodiments, at least one of the fourth segment and the fifth segment is a straight line: and/or at least one of the fourth segment and the fifth segment is a curve.

In some embodiments, the lens has a light-exiting surface corresponding to the light incident surface, the light incident surface is a light incident surface collimated in the Y direction, and the light-exiting surface is a light-exiting surface collimated in the Z direction.

In some embodiments, the light reflecting surface is a parabolic surface: and/or a size of the light reflecting surface in the Y direction is 5 mm˜15 mm; and/or a focal length of the light reflecting surface is 0.5 mm˜3 mm.

In some embodiments, another part of the plurality of optical units is a symmetrical unit, and the symmetrical unit satisfies that the optical axis of the symmetrical unit intersects with the geometric centerline of the light reflecting surface.

In some embodiments, a plurality of symmetrical units are provided, in at least one of the symmetrical units, a second low-beam cut-off line capable of forming a second light and dark cut-off line is provided at one end of the light reflecting surface away from the light incident surface, the second low-beam cut-off line has a third inflection point capable of forming an elbow of the second light and dark cut-off line, and the third inflection point is provided on the optical axis of the symmetrical unit.

A vehicle lamp of embodiments of the present disclosure includes the projection assembly according to any of the above embodiments.

A vehicle of embodiments of the present disclosure includes the vehicle lamp according to any of the above embodiments.

In the description of the present disclosure, it should be understood that orientations or position relationships indicated by terms “central”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, “circumferential”, etc. are based on the orientations or position relationships illustrated in the accompanying drawings, and are only for convenience of describing the present disclosure and simplifying the description, rather than indicating or implying that devices or components referred to must have a particular orientation, be constructed and operated in the particular orientation. Therefore, it cannot be understood as a limitation on the present disclosure.

In addition, terms “first” and “second” are only used to describe the purpose and cannot be understood as indicating or implying relative importance or implying the quantity of technical features indicated. Therefore, features limited to “first” and “second” may explicitly or implicitly include at least one of these features. In the description disclosed herein, “a plurality of” means at least two, such as two, three, etc., unless otherwise specified with specific limitations.

In the present disclosure, unless otherwise specified and limited, terms “mount”, “couple”, “connect”, “fix” and other terms should be broadly understood. For example, they may be a fixed connection, a detachable connection, or integrated. They may also be a mechanical connection, an electrical connection or communication with each other. They may be directly coupled or indirectly coupled through an intermediate medium. They may be an internal connection of two components or an interaction relationship between two components, unless otherwise specified. For ordinary those skilled in the art, specific meanings of the above terms in the present disclosure may be understood based on specific cases.

In the present disclosure, unless otherwise specified and limited, the first feature is “above” or “below” the second feature, which means that the first feature may be in direct contact with the second features, or the first feature may be in indirect contact with the second features through an intermediate media. Moreover, if the first feature is “on”, “above” and “on top of” the second feature, which means that the first feature is directly or diagonally above the second feature, or simply indicates that the first feature is horizontally higher than the second feature. The first feature is “under”, “below” and “on bottom of” the second feature, which means that the first feature is directly or diagonally below the second feature, or simply indicates that the horizontal height of the first feature is less than that of the second feature.

In the present disclosure, terms “an embodiment”, “some embodiments”, “an example”, “a specific examples”, or “some examples” means that a specific feature, structure, material, or characteristic described in connection with embodiments or examples is included in at least one embodiment or example of the present disclosure. In this specification, the illustrative expressions of the above terms do not necessarily refer to the same embodiments or examples. Moreover, the specific feature, structure, material, or characteristic described may be combined in any suitable manner in one or more embodiments or examples. In addition, those skilled in the art may connect and combine different embodiments or examples as well as features of different embodiments or examples described in this specification, without conflicting with each other.

Although embodiments of the present disclosure have been illustrated and described above, it may be understood that the above embodiments are illustrative and cannot be understood as a limitation of the present disclosure. Those ordinary skilled in the art may make changes, modifications, alternatives, and variations to the above embodiments within the scope of the present disclosure.

1. A projection assembly, comprising a plurality of optical units, wherein each optical unit comprises:
a reflecting mirror having a light reflecting surface; and
a lens having a light incident surface, and the light incident surface being arranged corresponding to the light reflecting surface;
wherein each optical unit has an optical axis extending along an X direction, the light reflecting surface and the corresponding light incident surface are arranged along the X direction, part of the plurality of optical units is an asymmetric unit, and the asymmetric unit satisfies that the optical axis and a geometric centerline of the light reflecting surface are spaced apart along a Y direction in a same asymmetric unit.

2. The projection assembly according to claim 1, wherein in the asymmetric unit, a first low-beam cut-off line capable of forming a first light and dark cut-off line is provided on a side of the light reflecting surface away from the light incident surface, the first low-beam cut-off line has a first inflection point capable of forming an elbow of the first light and dark cut-off line, and the first inflection point is provided on the optical axis of the asymmetric unit.

3. The projection assembly according to claim 1, wherein a plurality of asymmetric units are provided, the plurality of asymmetric units are arranged along the Y direction, two asymmetric units of the plurality of asymmetric units form an asymmetric unit group, and the asymmetric unit group satisfies that the optical axis of each asymmetric unit is located between geometric centerlines of two light reflecting surfaces in the Y direction.

4. The projection assembly according to claim 3, wherein in the asymmetric unit group, one of the two asymmetric units is a first asymmetric unit, another of the two asymmetric units is a second asymmetric unit, a distance between the optical axis and the geometric centerline of the light reflecting surface in the first asymmetric unit is L1, a distance between the optical axis and the geometric centerline of the light reflecting surface in the second asymmetric unit is L2, and L1 is equal to L2 or L1 is greater than L2.

5. The projection assembly according to claim 4, wherein a size of the light reflecting surface of the first asymmetric unit in the Y direction is L01, and a size of the light reflecting surface of the second asymmetric unit in the Y direction is L02;
at least one of a ratio of L1 to L01 or a ratio of L2 to L02 is 0.05˜0.49.

6. The projection assembly according to claim 3, wherein a plurality of asymmetric unit groups are provided, and the plurality of asymmetric unit groups are arranged along the Y direction.

7. The projection assembly according to claim 6, wherein at least one of the plurality of asymmetric unit groups is a first asymmetric unit group, and at least one of the plurality of asymmetric unit groups is a second asymmetric unit group,
in the first asymmetric unit group, one of the two asymmetric units is a first asymmetric unit, another of the two asymmetric units is a second asymmetric unit, a distance between the optical axis and the geometric centerline of the light reflecting surface in the first asymmetric unit is L1, a distance between the optical axis and the geometric centerline of the light reflecting surface in the second asymmetric unit is L2,
in the second asymmetric unit group, one of the two asymmetric units is a third asymmetric unit, and another of the two asymmetric units is a fourth asymmetric unit, a distance between the optical axis and the geometric centerline of the light reflecting surface in the third asymmetric unit is L3, a distance between the optical axis and the geometric centerline of the light reflecting surface in the fourth asymmetric unit is L4, and
L1 is equal to L2, L3 is equal to L4, and L3 is greater than L1.

8. The projection assembly according to claim 7, wherein a size of the light reflecting surface of the first asymmetric unit in the Y direction is L01, a size of the light reflecting surface of the second asymmetric unit in the Y direction is L02, a size of the light reflecting surface of the third asymmetric unit in the Y direction is L03, and a size of the light reflecting surface of the fourth asymmetric unit in the Y direction is L04;
a ratio of L1 to L01 is 0.05˜0.35,
a ratio of L2 to L02 is 0.05˜0.35,
a ratio of L3 to L03 is 0.1˜0.49, and
a ratio of L4 to L04 is 0.1˜0.49.

9. The projection assembly according to claim 3, wherein the two asymmetric units in the asymmetric unit group are arranged adjacent to each other.

10. The projection assembly according to claim 3, wherein in the asymmetric unit group, light incident surfaces of the two asymmetric units are symmetrically arranged in the Y direction.

11. The projection assembly according to claim 2, wherein the first low-beam cut-off line comprises a first segment, a second segment, and a third segment sequentially coupled along the Y direction, the first segment and the third segment are spaced apart in a Z direction, the second segment is inclined, a joint between the third segment and the second segment forms the first inflection point, a joint between the first segment and the second segment forms a second inflection point, and the second inflection point is capable of forming a shoulder of the first light and dark cut-off line;
an inclination angle of the second segment is 45°.

12. The projection assembly according to claim 11, wherein the first low-beam cut-off line further comprises a fourth segment and a fifth segment, the third segment, the fourth segment, and the fifth segment are coupled sequentially along the Y direction, the third segment and the fifth segment are spaced apart in the Z direction, the fourth segment is inclined, and the fourth segment is located between the first segment and the third segment in the Z direction.

13. The projection assembly according to claim 12, wherein at least one of the fourth segment and the fifth segment is a straight line.

14. The projection assembly according to claim 1, wherein the lens has a light-exiting surface corresponding to the light incident surface, the light incident surface is collimated in the Y direction, and the light-exiting surface is collimated in a Z direction.

15. The projection assembly according to claim 1, wherein the light reflecting surface is a parabolic surface.

16. The projection assembly according to claim 1, wherein another part of the plurality of optical units is a symmetrical unit, and the symmetrical unit satisfies that the optical axis intersects with the geometric centerline of the light reflecting surface in the same symmetrical unit.

17. The projection assembly according to claim 16, wherein a plurality of symmetrical units are provided, in at least one of the plurality of symmetrical units, a second low-beam cut-off line capable of forming a second light and dark cut-off line is provided at one end of the light reflecting surface away from the light incident surface, the second low-beam cut-off line has a third inflection point capable of forming an elbow of the second light and dark cut-off line, and the third inflection point is provided on the optical axis of the symmetrical unit.

18. A vehicle lamp, comprising:
a projection assembly comprising a plurality of optical units, wherein each optical unit comprises:
a reflecting mirror having a light reflecting surface; and
a lens having a light incident surface, and the light incident surface being arranged corresponding to the light reflecting surface;
wherein each optical unit has an optical axis extending along an X direction, the light reflecting surface and the corresponding light incident surface are arranged along the X direction, part of the plurality of optical units is an asymmetric unit, and the asymmetric unit satisfies that the optical axis and a geometric centerline of the light reflecting surface are spaced apart along a Y direction in a same asymmetric unit.

19. A vehicle, comprising:
a vehicle lamp comprising:
a projection assembly comprising a plurality of optical units;
wherein each optical unit comprises:
a reflecting mirror having a light reflecting surface; and
a lens having a light incident surface, and the light incident surface being arranged corresponding to the light reflecting surface;
wherein each optical unit has an optical axis extending along an X direction, the light reflecting surface and the corresponding light incident surface are arranged along the X direction, part of the plurality of optical units is an asymmetric unit, and the asymmetric unit satisfies that the optical axis and a geometric centerline of the light reflecting surface are spaced apart along a Y direction in a same asymmetric unit.

20. The projection assembly according to claim 6, wherein at least one of the plurality of asymmetric unit groups is a first asymmetric unit group, and at least one of the plurality of asymmetric unit groups is a second asymmetric unit group,
in the first asymmetric unit group, one of the two asymmetric units is a first asymmetric unit, another of the two asymmetric units is a second asymmetric unit, a distance between the optical axis and the geometric centerline of the light reflecting surface in the first asymmetric unit is L1, a distance between the optical axis and the geometric centerline of the light reflecting surface in the second asymmetric unit is L2,
in the second asymmetric unit group, one of the two asymmetric units is a third asymmetric unit, and another of the two asymmetric units is a fourth asymmetric unit, a distance between the optical axis and the geometric centerline of the light reflecting surface in the third asymmetric unit is L3, a distance between the optical axis and the geometric centerline of the light reflecting surface in the fourth asymmetric unit is L4, and
L1 is greater than L2, and L3 is greater than L4.
